(19) United States
(12) Patent Application Publication
(10) Pub. No.: US 2024/0030705 A1
(43) Pub. Date: Jan. 25, 2024

(54) INTERPRETABLE POWER LOAD PREDICTION METHOD, SYSTEM AND TERMINAL MACHINE

(71) Applicants: State Grid Information & Telecommunication Group Co., Ltd., Beijing (CN); SICHUAN ZHONGDIAN AOSTAR INFORMATION TECHNOLOGIES CO., LTD., Chengdu (CN); TIANJIN RICHSOFT ELECTRIC POWER INFORMATION TECHNOLOGY CO., LTD., Tianjin (CN); State Grid Info-Telecom Great Power Science and Technology Co., Ltd., Xiamen (CN)

(72) Inventors: Qiang Li, Beijing (CN); Zhu Liu, Beijing (CN); Wenjing Li, Beijing (CN); Liyuan Gao, Beijing (CN); Yumin Liu, Beijing (CN); Feihu Huang, Chengdu (CN); Xuxin Yang, Beijing (CN); Shilei Dong, Chengdu (CN); Tianyang Li, Beijing (CN); Honglei Zhao, Chengdu (CN); Meng Ming, Beijing (CN); Zhongyu Shang, Chengdu (CN); Chunyang Li, Beijing (CN); Mingtao Cui, Beijing (CN); Peiyao Zhang, Beijing (CN); Hongyue Ma, Beijing (CN); Bin Dai, Tianjin (CN); Dashuai Tan, Tianjin (CN); Xiao Feng, Beijing (CN); Xiaokang Lin, Fuzhou (CN)

(21) Appl. No.: 18/374,038

(22) Filed: Sep. 28, 2023

Related U.S. Application Data
(63) Continuation of application No. PCT/CN2023/099016, filed on Jun. 8, 2023.

(30) Foreign Application Priority Data
Jun. 14, 2022 (CN) 202210668260.0

(51) Int. Cl. H02J 3/00; G06N 3/045

(52) U.S. Cl. CPC H02J 3/003; G06N 3/045; H02J 2203/20

(57) ABSTRACT

The present invention provides an interpretable power load prediction method, system and terminal machine, relating to the field of power load prediction. The method comprises: initializing three factors—seasonal factor, trend factor, and smoothing factor, denoted as S₁, T₁, and I₁ respectively; calculating states of the three factors for time t+1 in a current DeepES unit; outputting the three factors Sₜ₊₁, Tₜ₊₁, and Iₜ₊₁ to a next DeepES unit; repeating until a n-th DeepES unit completes its operation; calculating a predicted value Y based on the three factors that are outputted from a final DeepES unit. In power load prediction, constructing an interpretable prediction model enables users to understand the inference process of the model, therefore helps enhance the credibility of the model.

### CROSS REFERENCE TO RELATED APPLICATIONS

The present application is a Continuation Application of PCT Application No. PCT/CN2023/099016 filed on Jun. 8, 2023, which claims the benefit of Chinese Patent Application No. 202210668260.0 filed on Jun. 14, 2022. All the above are hereby incorporated by reference.

### FIELD OF THE INVENTION

The present invention relates to the field of power load prediction, particularly to an interpretable power load prediction method, a system, and a terminal machine.

### BACKGROUND OF THE INVENTION

Existing power load prediction can be divided into two main categories. One category is load prediction methods based on statistical models. These methods are constructed on mathematical and statistical theories and have good interpretability. Common examples include auto-regressive moving average models, auto-regressive models, and other time series models. In addition, there are prediction methods that are based on Kalman filtering and prediction methods that are based on exponential smoothing. The other category is prediction methods based on neural networks, which are currently the mainstream prediction methods. Among these, recurrent neural networks (RNNs), particularly Long Short-Term Memory (Long Short-Term Memory, LSTM) and Gate Recurrent Unit (Gate Recurrent Unit, GRU), are widely used in load prediction.

In existing techniques, the prediction methods based on statistical models are characterized by strong interpretability, but their performance is not as good as that of the prediction methods based on neural networks. Conversely, neural network models have strong non-linear mapping capabilities and can achieve effective load prediction. However, the major limitation of neural network models lies in model interpretability. Since neural networks are essentially black boxes, it is difficult to understand the process through which the model extracts load sequence characteristics within the network, and this affects the credibility of power load prediction.

### SUMMARY OF THE INVENTION

To overcome the limitations of the aforementioned existing techniques, the present invention provides an interpretable power load prediction method. The power load prediction method combines exponential smoothing models with deep learning, referred to as Deep Exponential Smoothing (Deep Exponential Smoothing, DeepES) model. On one hand, it leverages the advantages of deep learning in extracting time-sequence characteristics. On the other hand, it makes use of the interpretable characteristics of the exponential smoothing models, thereby making the method have good interpretability.

The method comprises: step 1, initializing three factors—seasonal factor, trend factor, and smoothing factor, denoted as S₁, T₁, and I₁ respectively;
step 2, calculating states of the three factors for time t+1 in a current DeepES unit, namely Sₜ₊₁, Tₜ₊₁, and Iₜ₊₁;
step 3, outputting, by the current DeepES unit, the three factors Sₜ₊₁, Tₜ₊₁, and Iₜ₊₁ to a next DeepES unit;
step 4, repeating steps 2 to 3 until a n-th DeepES unit completes its operation;
step 5, calculating a predicted value Y based on the three factors that are outputted from a final DeepES unit.

One thing to be further illustrated is that the steps 1 to 3 comprise: constructing a network framework;
setting an activation function within the network framework and utilizing the network framework to calculate the states of the three factors for the time t+1 in the current DeepES unit;
outputting, by the current DeepES unit, the Sₜ₊₁, Tₜ₊₁, and Iₜ₊₁ calculated by the network framework to the next DeepES unit.

One thing to be further illustrated is that the process of initializing the factors in step 1 further comprises:
given an input sequence {X₁, X₂, . . . , Xₙ}, where X represents power load data and a length of the input sequence is n;
taking first k values of the input sequence, denoted as {X₁, X₂, . . . , Xₖ}, calculating a mean (Xₘₑₐₙ), a variance (Xᵥₐᵣ), and a horizontal proportion (Xₚ) of the input sequence, wherein the calculation formulas for these three metrics are as follows:

$${X}_{mean} = \frac{1}{k} {\sum }_{i = 1}^{k} {X}_{i} \\ {X}_{var} = \frac{1}{k} {\sum }_{i = 1}^{k} {( {X}_{i} - {X}_{mean} )}^{2} \\ {X}_{p} = \frac{n \cdot {X}_{mean}}{{\sum }_{i = 1}^{n} {X}_{i}}$$

after obtaining the three metrics Xₘₑₐₙ, Xₚₐᵣ and Xₚ, obtaining a value Xᵢₙᵢₜ through InitNet network for initializing the factors;
after obtaining Xᵢₙᵢₜ, initializing the three factors as follows:

S₀=[Xᵢₙᵢₜ⁰, . . . ,Xᵢₙᵢₜ^{p-1}]

T₀=Xᵢₙᵢₜ^{p}

I₀=Xᵢₙᵢₜ^{p+1}

One thing to be further illustrated is that InitNet network's parameters are configured as follows:
an input data dimension of a first hidden layer is [1, k] meaning a number of input samples is 1 and a dimension of sample characteristics is k; an output dimension is [1, p] meaning a number of samples is 1 and a dimension of sample characteristics is p;
an input dimension of a second hidden layer is [1, p] meaning a number of input samples is 1 and a dimension of sample characteristics is p, an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p+2] meaning a number of samples is 1 and a dimension of sample characteristics is p+2.

One thing to be further illustrated is that the step of calculating states of the three factors for time t+1 in a current DeepES unit further comprises the following:
given that an input sequence is {X₁, X₂, . . . , Xₙ}, the number of iterations is n, the currently executing step is t;
calculating the smoothing factor Iₜ₊₁ for the time t+1 with the following calculation formulas:

Iₚ₁^{t}=TempNet(concat(Xₜ,Sₜ))

Iₚ₂^{t}=TempNet(concat(Iₜ,Tₜ))

Iₜ₊₁=Iₚ₁^{t}+Iₚ₂^{t}
where concat(·) represents a concatenation operation of two vectors and TempNet refers to TempNet calculation network;

TempNet's parameters are configured as follows:
an input dimension of a hidden layer is [1, 2p] meaning a number of input samples is 1 and a dimension of sample characteristics is 2p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p] meaning a number of samples is 1 and a dimension of sample characteristics is p.

One thing to be further illustrated is that the method further comprises: calculating the trend factor Tₜ₊₁ for the time t+1 with the following calculation formulas:

Tₚ₁^{t}=TempNet(concat(Iₜ,Iₜ₊₁))

Tₜ₊₁=Tₚ₁^{t}+Tₜ
where concat(·) represents a concatenation operation of two vectors and TempNet refers to TempNet calculation network.

One thing to be further illustrated is that the method further comprises: calculating the seasonal factor Sₜ₊₁ for the time t+1 with the following formulas:

Sₚ₁^{t}=TempNet(concat(Xₜ,Iₜ₊₁))

Sₜ₊₁=Sₚ₁^{t}+Sₜ
where concat(·) represents a concatenation operation of two vectors and TempNet refers to TempNet calculation network.

One thing to be further illustrated is that in step 5, the calculation of the predicted value Y based on the three factors, namely Sₗₐₛₜ, Tₗₐₛₜ, and Iₗₐₛₜ that are outputted from the final DeepES unit is performed with the following calculation formula:

Y=PreNet(concat(Sₗₐₛₜ,Tₗₐₛₜ,Iₗₐₛₜ))
where concat(·) represents a concatenation operation of two vectors and PreNet refers to PreNet prediction network;

PreNet prediction network's parameters are configured as follows:
an input data dimension of a first hidden layer is [1, 3p] meaning a number of input samples is 1 and a dimension of sample characteristics is 3p; an output dimension is [1, p] meaning a number of samples is 1 and a dimension of sample characteristics is p;
an input dimension of a second hidden layer is [1, p] meaning a number of input samples is 1 and a dimension of sample characteristics is p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, 1] meaning a number of samples is 1 and a dimension of sample characteristics is 1.

The present invention also provides an interpretable power load prediction system. The system comprises: an initialization module, a first state calculation module, an iterative calculation module, and a prediction module;
the initialization module is used for initializing three factors—seasonal factor, trend factor, and smoothing factor, denoted as S₁, T₁, and I₁ respectively;
the first state calculation module is used for calculating states of the three factors for time t+1 in a current DeepES unit, namely Sₜ₊₁, Tₜ₊₁, and Iₜ₊₁;
the iterative calculation module is used for outputting, in an iterative calculation manner, the three factors Sₜ₊₁, Tₜ₊₁, and Iₜ₊₁ to a next DeepES unit; calculating iteratively the states of the three factors for the time t+1 in the DeepES unit until a n-th DeepES unit completes its operation;
the prediction module is used for calculating a predicted value Y based on the three factors that are outputted from a final DeepES unit.

The present invention further provides a terminal machine for implementing an interpretable power load prediction method, the terminal machine comprises:
a memory, used for storing a computer program that is executable on a processor;
a processor, used for executing the computer program to implement an interpretable power load prediction method.

It can be seen from the above technical solutions that the present invention has the following advantages:

By calculating the three factors—seasonal factor, trend factor, and smoothing factor, the interpretable power load prediction method provided by the present invention achieves the goal of being interpretable. The seasonal factor is used to describe the seasonal characteristics of the sequence, the trend factor describes the trend direction of the sequence, and the smoothing factor describes the smoothness of the sequence. In power load prediction, constructing an interpretable prediction model enables users to understand the inference process of the model, therefore helps enhance the credibility of the model.

### BRIEF DESCRIPTION OF THE DRAWINGS

To provide a clearer illustration of the technical solutions of the present invention, a brief introduction to the drawings used in the description will be provided below. Clearly, the drawings in the description below are merely some embodiments of the present invention. Those skilled in the art can obtain additional drawings based on these drawings without exercising creative effort.

FIG. 1 is a flowchart of an interpretable power load prediction method.

FIG. 2 is a diagram of a network structure of a DeepES unit.

FIG. 3 is a diagram of a network structure of InitNet.

FIG. 4 is a diagram of a network structure of TempNet.

FIG. 5 is a diagram of a network structure of PreNet.

FIG. 6 is a schematic diagram of an interpretable power load prediction system.

FIG. 7 is a schematic diagram of an embodiment of an interpretable power load prediction system.

### DETAILED DESCRIPTION OF THE INVENTION

Now, with reference to the drawings in the embodiments of the present invention, the technical solutions in the embodiments of the present invention will be described clearly and comprehensively. Clearly, the described embodiments are only a portion of the embodiments of the present invention, rather than all of the embodiments. Based on the embodiments of the present invention, all other embodiments that those skilled in the art may derive without exercising creative effort fall within the scope of protection of the present invention.

The exemplary units and algorithmic steps described in the disclosed embodiments of the interpretable power load prediction method and system provided by the present invention can be implemented with computer hardware, software, or a combination of both. In order to illustrate the interchangeability of hardware and software, various exemplary compositions and procedures have been generally described in the above description according to their functions. Whether these functions are implemented in hardware or software depends on the specific application and design constraints of the technical solution. Those skilled individuals can use different approaches for each specific application to implement the described functions, but such implementation should not be considered beyond the scope of the present invention.

The block diagrams shown in the drawings of the interpretable power load prediction method and system provided by the present invention are merely functional entities and do not necessarily have to correspond to physically independent entities. In other words, these functional entities can be implemented in the form of software, or these functional entities can be implemented in one or more hardware modules or integrated circuits, or these functional entities can be implemented in different networks and/or processor devices and/or micro-controller devices.

In the interpretable power load prediction method and system provided by the present invention, it should be understood that the disclosed systems, devices, and methods can be implemented in other ways. For example, the described device embodiments are merely illustrative. For example, the division of units is just a logical functional division, and the actual implementation may have different divisions. For example, multiple units or components can be combined or integrated into another system, or some characteristics may be omitted or not executed. Additionally, the shown or discussed coupling or direct coupling or communication connections between one another can be indirect coupling or communication connection through interfaces, devices, or units, and can also be a connection in the form of electrical, mechanical, or other types.

The interpretable power load prediction method and system provided by the present invention are aiming to address the limitation of poor model interpretability of the neural networks in the prior art. The power load prediction method involved in the present invention clarifies the process through which the model extracts load sequence characteristics, thereby enhancing the credibility of power load prediction.

In this regard, the present invention combines exponential smoothing models with deep learning. On one hand, it leverages the advantages of deep learning in extracting time-sequence characteristics, on the other hand, it makes use of the interpretable characteristics of the exponential smoothing models, so as to construct an interpretable power load prediction method and system which have a good interpretability.

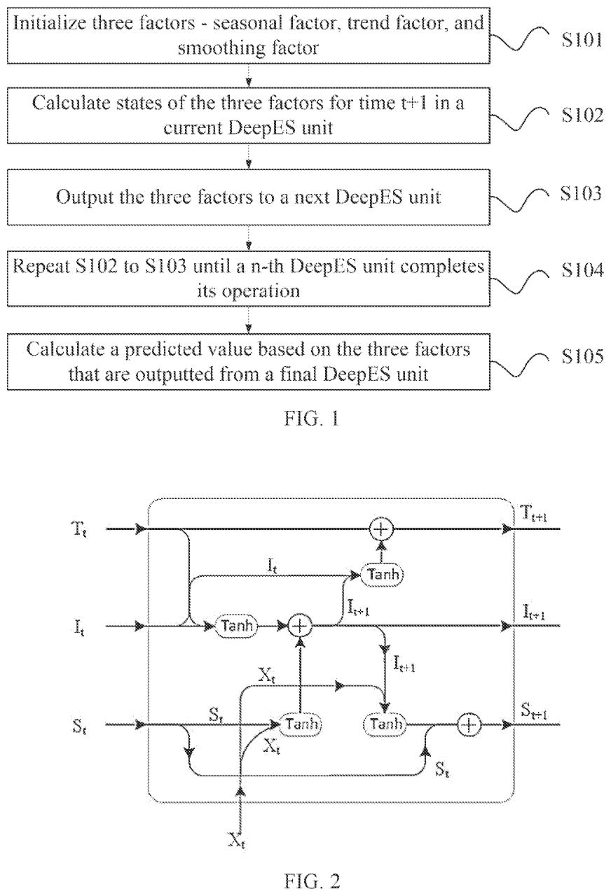

As shown in FIG. 1, the interpretable power load prediction method provided by the present invention includes the following steps.

S101, Initialize three factors—seasonal factor, trend factor, and smoothing factor, denoted as S₁, T₁, and I₁ respectively.

Specifically, the input of the first DeepES unit is S₁, T₁, and I₁, namely the seasonal factor, trend factor, and smoothing factor. The framework of the DeepES unit is illustrated in FIG. 2. Several places in this figure are marked with “Tanh” indicating the corresponding position in the framework will be employed with a network module. The network module is an activation function, which is Tanh.

Regarding the process of initializing the factors, the solution provided by the present invention is as follows. Denote an input sequence as {X₁, X₂, . . . , Xₙ}, where X represents power load data and a length of the input sequence is n. Take first k values of the input sequence, denoted as {X₁, X₂, . . . , Xₖ}, and calculate a mean, a variance, and a horizontal proportion of the input sequence. The calculation formulas for these three metrics are as follows:

$${X}_{mean} = \frac{1}{k} {\sum }_{i = 1}^{k} {X}_{i} \\ {X}_{var} = \frac{1}{k} {\sum }_{i = 1}^{k} {( {X}_{i} - {X}_{mean} )}^{2} \\ {X}_{p} = \frac{n \cdot {X}_{mean}}{{\sum }_{i = 1}^{n} {X}_{i}}$$

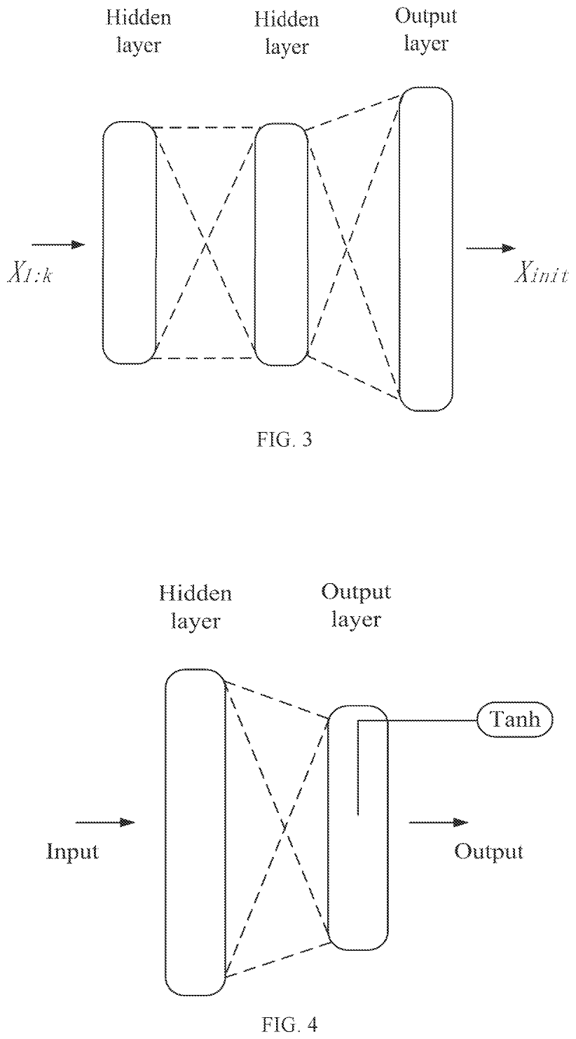

After obtaining the three metrics Xₘₑₐₙ, Xₚₐᵣ and Xₚ, obtain a value Xᵢₙᵢₜ through an initialization network InitNet for initializing the factors. The design of the InitNet network is shown in FIG. 3. After obtaining Xᵢₙᵢₜ, initialize the three factors as follows:

S₀=[Xᵢₙᵢₜ⁰, . . . ,Xᵢₙᵢₜ^{p-1}]

T₀=Xᵢₙᵢₜ^{p}

I₀=Xᵢₙᵢₜ^{p+1}

InitNet network's parameters are configured as follows:
an input data dimension of a first hidden layer is [1, k] meaning a number of input samples is 1 and a dimension of sample characteristics is k; an output dimension is [1, p] meaning a number of samples is 1 and a dimension of sample characteristics is p;
an input dimension of a second hidden layer is [1, p] meaning a number of input samples is 1 and a dimension of sample characteristics is p, an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p+2] meaning a number of samples is 1 and a dimension of sample characteristics is p+2.

S102, Calculate states of the three factors for time t+1 in a current DeepES unit, namely Sₜ₊₁, Tₜ₊₁, and Iₜ₊₁.

S103, Output the three factors Sₜ₊₁, Tₜ₊₁, and Iₜ₊₁ to a next DeepES unit.

S104, Repeat S102 to S103 until a n-th DeepES unit completes its operation.

S102 to S104 are operated in an iterative manner. The number of iterations is equal to the dimension of the input data. For example, if the input sequence is {X₁, X₂, . . . , Xₙ}, the number of iterations is n.

DeepES unit is the execution unit for each iteration step. Below is a detailed description of the execution flow in the DeepES unit, denoting the currently executing step as t:

\textcircled{1} Calculate the smoothing factor Iₜ₊₁ for the time t+1 with the following calculation formulas:

Iₚ₁^{t}=TempNet(concat(Xₜ,Sₜ))
where concat(·) represents a concatenation operation of two vectors and TempNet is a calculation network involved. The design of the network is shown in FIG. 4. TempNet's parameters are configured as follows:
an input dimension of a hidden layer is [1, 2p] meaning a number of input samples is 1 and a dimension of sample characteristics is 2p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p] meaning a number of samples is 1 and a dimension of sample characteristics is p.

\textcircled{2} Calculate the trend factor Tₜ₊₁ for the time t+1 with the following calculation formulas:

Tₚ₁^{t}=TempNet(concat(Iₜ,Iₜ₊₁))

Tₜ₊₁=Tₚ₁^{t}+Tₜ
where concat(·) represents a concatenation operation of two vectors and TempNet is a calculation network involved. The design of this network is consistent with the design of the network for the smoothing factor Iₜ₊₁.

\textcircled{3} Calculate the seasonal factor Sₜ₊₁ for the time t+1 with the following formulas:

Sₚ₁^{t}=TempNet(concat(Xₜ,Iₜ₊₁))

Sₜ₊₁=Sₚ₁^{t}+Sₜ
where concat(·) represents a concatenation operation of two vectors and TempNet is a calculation network involved. The design of this network is consistent with the design of the network for the smoothing factor Iₜ₊₁.

S105, Calculate a predicted value Y based on the three factors that are outputted from a final DeepES unit.

In S105, the calculation of the predicted value Y is based on the three factors that are outputted from the final DeepES unit, namely Sₗₐₛₜ, Tₗₐₛₜ, and Iₗₐₛₜ, and the calculation of the predicted value Y is performed with following calculation formula:

Y=PreNet(concat(Sₗₐₛₜ,Tₗₐₛₜ,Iₗₐₛₜ))
where concat(·) represents a concatenation operation of two vectors and PreNet is a prediction network involved which is shown in FIG. 5. The prediction network's parameters are configured as follows:
an input data dimension of a first hidden layer is [1, 3p] meaning a number of input samples is 1 and a dimension of sample characteristics is 3p; an output dimension is [1, p] meaning a number of samples is 1 and a dimension of sample characteristics is p;
an input dimension of a second hidden layer is [1, p] meaning a number of input samples is 1 and a dimension of sample characteristics is p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, 1] meaning a number of samples is 1 and a dimension of sample characteristics is 1.

In the embodiments of the present invention, the construction of the network framework in step 1 is the construction of a neural network. The DeepES unit and the network modules are components of the neural network. The structures for carrying these components can each be one or more processors or chips with communication interfaces that are capable of implementing communication protocols. If necessary, these structures can also include memories and relevant interfaces, system transport buses, etc. The processors or chips execute program-related codes to achieve respective functions.

By calculating the three factors—seasonal factor, trend factor, and smoothing factor, the interpretable power load prediction method provided by the present invention achieves the goal of being interpretable. The seasonal factor is used to describe the seasonal characteristics of the sequence, the trend factor describes the trend direction of the sequence, and the smoothing factor describes the smoothness of the sequence. In power load prediction, constructing an interpretable prediction model enables users to understand the inference process of the model, therefore helps enhance the credibility of the model.

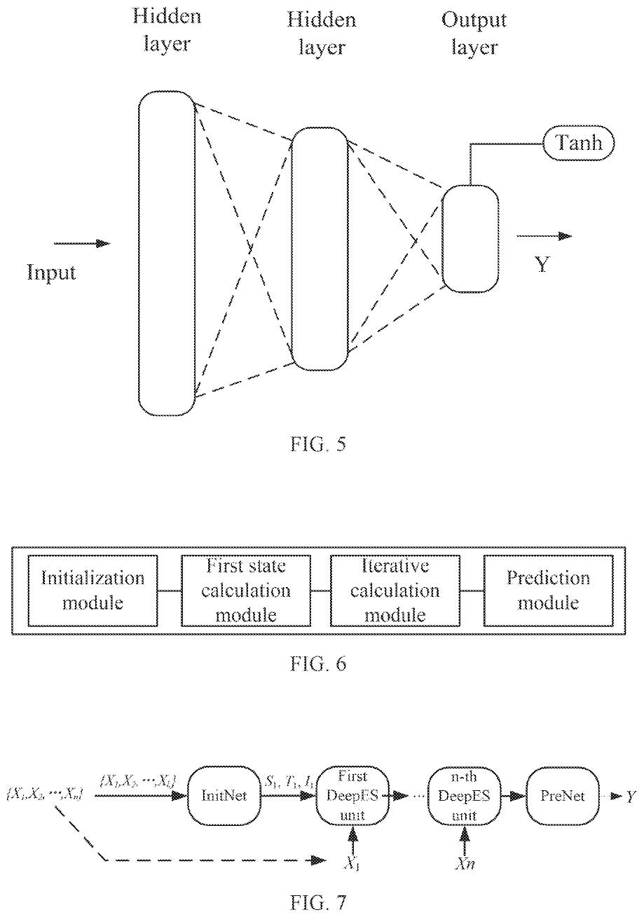

Based on the aforementioned methods, the present invention also provides an interpretable power load prediction system. As shown in FIG. 6 and FIG. 7, the system comprises: an initialization module, a first state calculation module, an iterative calculation module, and a prediction module.

The initialization module is used for initializing three factors—seasonal factor, trend factor, and smoothing factor, denoted as S₁, T₁, and I₁ respectively.

The first state calculation module is used for calculating states of the three factors for time t+1 in the current DeepES unit, namely Sₜ₊₁, Tₜ₊₁, and Iₜ₊₁.

The iterative calculation module is used for outputting, in an iterative calculation manner, the three factors Sₜ₊₁, Tₜ₊₁, and Iₜ₊₁ to a next DeepES unit; calculating iteratively the states of the three factors for the time t+1 in the DeepES unit until a n-th DeepES unit completes its operation.

The prediction module is used for calculating a predicted value Y based on the three factors that are outputted from a final DeepES unit.

In the embodiments of the present invention, the initialization module, the first state calculation module, the iterative calculation module, and the prediction module can each be one or more processors or chips with communication interfaces that are capable of implementing communication protocols. If necessary, they can also include memories and relevant interfaces, system transport buses, etc. The processors or chips execute program-related codes to achieve respective functions. Or, an alternative approach may be that the initialization module, the first state calculation module, the iterative calculation module, and the prediction module share an integrated chip, or share a processor, a memory, and other devices. The shared processor or chip executes relevant codes to implement the respective functions.

The interpretable power load prediction system provided by the present invention is configured with a DeepES model, which can express complex nonlinear relationships between factors through a neural network.

On the basis of the input sequence, the system calculates the mean, the variance, and the horizontal proportion of the sequence, obtains the value for initializing the factors through the InitNet initialization network, and then obtains the seasonal factor, the trend factor, and the smoothing factor.

The system can calculate iteratively the states of these three factors for time t+1, namely Sₜ₊₁, Tₜ₊₁, and Iₜ₊₁; output these factors Sₜ₊₁, Tₜ₊₁, and Iₜ₊₁ to the next DeepES unit; calculate iteratively the states of the three factors for time t+1 in the DeepES unit until the n-th DeepES unit completes its operation; calculate the predicted value Y based on the three factors Sₗₐₛₜ, Tₗₐₛₜ, and Iₗₐₛₜ that are outputted from the final DeepES unit. The present invention enables users to understand the inference process of the model, therefore helps enhance the credibility of the model.

To execute the power load prediction method provided by this invention on a terminal machine, the terminal machine comprises: a memory, used for storing a computer program that is executable on a processor; a processor, used for executing the computer program to implement an interpretable power load prediction method.

The terminal machine further comprises: an input section like an I/O interface, a keyboard, a mouse, etc.; an output section like a LCD display, a speaker, etc.; a communication section comprising a network interface card such as LAN (Local Area Network) card and a modem. The communication section executes a communication processing through a network such as the Internet.

By calculating the three factors, the terminal machine based on which the interpretable power load prediction method is implemented achieves the goal of being interpretable. Among the factors, the seasonal factor is used to describe the seasonal characteristics of the sequence, the trend factor describes the trend direction of the sequence, and the smoothing factor describes the smoothness of the sequence. Furthermore, the terminal machine constructs an interpretable prediction model that enables users to understand the inference process of the model, therefore helps enhance the credibility of the model.

The interpretable power load prediction method and system provided by the present invention involve various exemplary units and algorithm steps described in conjunction with the embodiments disclosed herein, and the units and algorithm steps can be implemented with electronic hardware, computer software, or a combination of both. In order to illustrate the interchangeability of hardware and software, various exemplary compositions and procedures have been generally described in the above description according to their functions. Whether these functions are implemented in hardware or software depends on the specific application and design constraints of the technical solution. Those skilled individuals can use different approaches for each specific application to implement the described functions, but such implementation should not be considered beyond the scope of the present invention.

The above description of the disclosed embodiments enables those skilled in the art to implement or utilize the present invention. Various modifications to these embodiments will be evident to those skilled in the art, and the general principles defined herein can be implemented in other embodiments without departing from the spirit or scope of the invention. Therefore, the present invention is not limited to the embodiments shown herein but encompasses the widest scope consistent with the principles and novel characteristics disclosed herein.

1. An interpretable power load prediction method, wherein the method comprises:
step 1, initializing three factors—seasonal factor, trend factor, and smoothing factor, denoted as S₁, T₁, and I₁ respectively;
step 2, calculating states of the three factors for time t+1 in a current DeepES unit, namely Sₜ₊₁, Tₜ₊₁, and Iₜ₊₁;
step 3, outputting the three factors Sₜ₊₁, Tₜ₊₁, and Iₜ₊₁ to a next DeepES unit;
step 4, repeating steps 2 to 3 until a n-th DeepES unit completes its operation;
step 5, calculating a predicted value Y based on the three factors that are outputted from a final DeepES unit.

2. The interpretable power load prediction method according to claim 1, wherein
steps 1 to 3 comprise: constructing a network framework;
setting an activation function within the network framework and utilizing the network framework to calculate the states of the three factors for the time t+1 in the current DeepES unit;
outputting, by the current DeepES unit, the Sₜ₊₁, Tₜ₊₁, and Iₜ₊₁ calculated by the network framework to the next DeepES unit.

3. The interpretable power load prediction method according to claim 1, wherein
the process of initializing the factors in step 1 further comprises:
given an input sequence {X₁, X₂, . . . , Xₙ}, where X represents power load data and a length of the input sequence is n;
taking first k values of the input sequence, denoted as {X₁, X₂, . . . , Xₖ}, calculating a mean, a variance, and a horizontal proportion of the input sequence, wherein the calculation formulas for these three metrics are as follows:
$${X}_{mean} = \frac{1}{k} {\sum }_{i = 1}^{k} {X}_{i} \\ {X}_{var} = \frac{1}{k} {\sum }_{i = 1}^{k} {( {X}_{i} - {X}_{mean} )}^{2} \\ {X}_{p} = \frac{n \cdot {X}_{mean}}{{\sum }_{i = 1}^{n} {X}_{i}}$$
after obtaining the three metrics Xₘₑₐₙ, Xₚₐᵣ and Xₚ, obtaining a value Xᵢₙᵢₜ through InitNet network for initializing the factors;
after obtaining Xᵢₙᵢₜ, initializing the three factors as follows:
S₀=[Xᵢₙᵢₜ⁰, . . . ,Xᵢₙᵢₜ^{p-1}]
T₀=Xᵢₙᵢₜ^{p}
I₀=Xᵢₙᵢₜ^{p+1}

4. The interpretable power load prediction method according to claim 3, wherein
InitNet network's parameters are configured as follows:
an input data dimension of a first hidden layer is [1, k] meaning a number of input samples is 1 and a dimension of sample characteristics is k; an output dimension is [1, p] meaning a number of samples is 1 and a dimension of sample characteristics is p;
an input dimension of a second hidden layer is [1, p] meaning a number of input samples is 1 and a dimension of sample characteristics is p, an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p+2] meaning a number of samples is 1 and a dimension of sample characteristics is p+2.

5. The interpretable power load prediction method according to claim 1, wherein
the step of calculating states of the three factors for time t+1 in a current DeepES unit further comprises:
given that an input sequence is {X₁, X₂, . . . , Xₙ}, the number of iterations is n, the currently executing step is t,
calculating the smoothing factor Iₜ₊₁ for the time t+1 with the following calculation formulas:
Iₚ₁^{t}=TempNet(concat(Xₜ,Sₜ))
Iₚ₂^{t}=TempNet(concat(Iₜ,Tₜ)
Iₜ₊₁=Iₚ₁^{t}+Iₚ₂^{t}
where concat(·) represents a concatenation operation of two vectors and TempNet refers to TempNet calculation network;
TempNet's parameters are configured as follows:
an input dimension of a hidden layer is [1, 2p] meaning a number of input samples is 1 and a dimension of sample characteristics is 2p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p] meaning a number of samples is 1 and a dimension of sample characteristics is p.

6. The interpretable power load prediction method according to claim 5, wherein the method further comprises:
calculating the trend factor Tₜ₊₁ for the time t+1 with the following calculation formulas:
Tₚ₁^{t}=TempNet(concat(Iₜ,Iₜ₊₁))
Tₜ₊₁=Tₚ₁^{t}+Tₜ
where concat(·) represents a concatenation operation of two vectors and TempNet refers to TempNet calculation network.

7. The interpretable power load prediction method according to claim 5, wherein the method further comprises:
calculating the seasonal factor Sₜ₊₁ for the time t+1 with the following formulas:
Sₚ₁^{t}=TempNet(concat(Xₜ,Iₜ₊₁))
Sₜ₊₁=Sₚ₁^{t}+Sₜ
where concat(·) represents a concatenation operation of two vectors and TempNet refers to TempNet calculation network.

8. The interpretable power load prediction method according to claim 2, wherein
the step of calculating states of the three factors for time t+1 in a current DeepES unit further comprises:
given that an input sequence is {X₁, X₂, . . . , Xₙ}, the number of iterations is n, the currently executing step is t,
calculating the smoothing factor Iₜ₊₁ for the time t+1 with the following calculation formulas:
Iₚ₁^{t}=TempNet(concat(Xₜ,Sₜ))
Iₚ₂^{t}=TempNet(concat(Iₜ,Tₜ)
Iₜ₊₁=Iₚ₁^{t}+Iₚ₂^{t}
where concat(·) represents a concatenation operation of two vectors and TempNet refers to TempNet calculation network;
TempNet's parameters are configured as follows:
an input dimension of a hidden layer is [1, 2p] meaning a number of input samples is 1 and a dimension of sample characteristics is 2p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, p] meaning a number of samples is 1 and a dimension of sample characteristics is p.

9. The interpretable power load prediction method according to claim 8, wherein the method further comprises:
calculating the trend factor Tₜ₊₁ for the time t+1 with the following calculation formulas:
Tₚ₁^{t}=TempNet(concat(Iₜ,Iₜ₊₁))
Tₜ₊₁=Tₚ₁^{t}+Tₜ
where concat(·) represents a concatenation operation of two vectors and TempNet refers to TempNet calculation network.

10. The interpretable power load prediction method according to claim 8, wherein the method further comprises:
calculating the seasonal factor Sₜ₊₁ for the time t+1 with the following formulas:
Sₚ₁^{t}=TempNet(concat(Xₜ,Iₜ₊₁))
Sₜ₊₁=Sₚ₁^{t}+Sₜ
where concat(·) represents a concatenation operation of two vectors and TempNet refers to TempNet calculation network.

11. The interpretable power load prediction method according to claim 1, wherein in step 5, the calculation of the predicted value Y based on the three factors, namely Sₗₐₛₜ, Tₗₐₛₜ, and Iₗₐₛₜ that are outputted from the final DeepES unit is performed with the following calculation formula:
Y=PreNet(concat(Sₗₐₛₜ,Tₗₐₛₜ,Iₗₐₛₜ))
where concat(·) represents a concatenation operation of two vectors and PreNet refers to PreNet prediction network;
PreNet prediction network's parameters are configured as follows:
an input data dimension of a first hidden layer is [1, 3p] meaning a number of input samples is 1 and a dimension of sample characteristics is 3p; an output dimension is [1, p] meaning a number of samples is 1 and a dimension of sample characteristics is p;
an input dimension of a second hidden layer is [1, p] meaning a number of input samples is 1 and a dimension of sample characteristics is p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, 1] meaning a number of samples is 1 and a dimension of sample characteristics is 1.

12. The interpretable power load prediction method according to claim 2, wherein in step 5, the calculation of the predicted value Y based on the three factors, namely Sₗₐₛₜ, Tₗₐₛₜ, and Iₗₐₛₜ that are outputted from the final DeepES unit is performed with the following calculation formula:
Y=PreNet(concat(Sₗₐₛₜ,Tₗₐₛₜ,Iₗₐₛₜ))
where concat(·) represents a concatenation operation of two vectors and PreNet refers to PreNet prediction network;
PreNet prediction network's parameters are configured as follows:
an input data dimension of a first hidden layer is [1, 3p] meaning a number of input samples is 1 and a dimension of sample characteristics is 3p; an output dimension is [1, p] meaning a number of samples is 1 and a dimension of sample characteristics is p;
an input dimension of a second hidden layer is [1, p] meaning a number of input samples is 1 and a dimension of sample characteristics is p; an output dimension is [1, p] meaning a number of samples is 1 and a dimension of sample characteristics is p;
an input dimension of an output layer is [1, p] meaning a number of input samples is 1 and a dimension of sample characteristics is p; an output dimension is [1, 1] meaning a number of samples is 1 and a dimension of sample characteristics is 1.

13. An interpretable power load prediction system, wherein
the system comprises: an initialization module, a first state calculation module, an iterative calculation module, and a prediction module;
the initialization module is used for initializing three factors—seasonal factor, trend factor, and smoothing factor, denoted as S₁, T₁, and I₁ respectively;
the first state calculation module is used for calculating states of the three factors for time t+1 in a current DeepES unit, namely Sₜ₊₁, Tₜ₊₁, and Iₜ₊₁;
the iterative calculation module is used for outputting, in an iterative calculation manner, the three factors Sₜ₊₁, Tₜ₊₁, and Iₜ₊₁ to a next DeepES unit; calculating iteratively the states of the three factors for the time t+1 in the DeepES unit until a n-th DeepES unit completes its operation;
the prediction module is used for calculating a predicted value Y based on the three factors that are outputted from a final DeepES unit.

14. A terminal machine for implementing an interpretable power load prediction method, wherein the terminal machine comprises:
a memory, used for storing a computer program that is executable on a processor;
a processor, used for executing the computer program to implement an interpretable power load prediction method according to claim 1.
